(19) United States
(12) Patent Application Publication
(10) Pub. No.: US 2026/0010394 A1
(43) Pub. Date: Jan. 8, 2026

(54) SYSTEM(S) AND METHOD(S) FOR UTILIZATION OF GENERATIVE MODEL(S) IN GENERATING, UPDATING, AND/OR EXECUTING USER ROUTINE(S)

(71) Applicant: GOOGLE LLC, Mountain View, CA (US)

(72) Inventors: Gabi Lanning, Austin, TX (US); Jaime Guajardo, Austin, TX (US); Dmitrii Boiarshinov, Mountain View, CA (US)

(21) Appl. No.: 18/766,456

(22) Filed: Jul. 8, 2024

(51) Int. Cl. G06F 9/48

(52) U.S. Cl. CPC G06F 9/4881

(57) ABSTRACT

Implementations relate to receiving user input from a user that describes at least one type of action to be routinely performed, but without identifying any device or application in association with the at least one action, and in response, utilizing generative model(s) to determine action(s) to be performed by device(s) and/or applications, that are associated with the user, and in furtherance of executing a user routine. The action(s) can be determined based on processing, using the generative model(s), the user input and metadata associated with device(s) and/or application(s) that indicates capabilities of the device(s) and/or application(s). The user routine can be periodically modified or updated based on additional user input(s) and/or based on monitored performance (or lack thereof) of the user routine.

### BACKGROUND

Various generative model(s) (GM(s)) have been proposed that can be used to process user input(s), to generate output that reflects generative content that is responsive to the user input(s). For example, large language model(s) (LLM(s)) have been developed that can be used to process user input(s) to generate output(s) that reflect text-based generative content that is responsive to the user input(s). While user(s) typically interact with these GMs(s) by providing text-based user input(s) or speech-based user input(s), recent developments have also enabled user(s) to provide other content along with these text-based user input(s) or speech-based user input(s). For instance, user(s) can also upload document(s), image(s), etc. that is in addition to the text-based user input(s) or speech-based user input(s). As the user(s) continues interacting with these GM(s), a context of the interaction (e.g., prior text-based user input(s) or speech-based user input(s), prior output(s) generated by these GM(s), etc.) is continuously updated and utilized in generating subsequent output(s) as the interaction continues.

In many instances, this context is limited to explicit user input(s) and/or generative output(s) generated in response to the user input(s) throughout the course of this human-to-machine interaction. In some instances, this context is expanded beyond explicit user input(s) and/or generative output(s) generated in response to the user input(s) throughout the course of this human-to-machine interaction. For example, some user input(s) can cause these GM(s) to utilize external tools (e.g., extensions, plugins, etc.) to obtain additional content (e.g., search results) that can be added to the context and utilized by these GM(s) in generating generative output(s). However, these external tools are often generic to a population of users and, as a result, the generative output(s) are not personalized or tailored to a given user that provided a given user input. This lack of personalization or tailoring of the generative output(s) is exacerbated when the given user is seeking highly personalized generative output(s). Accordingly, there is a need in the art for more personalized or tailored external tools and/or external information that can be processed by these GM(s).

### SUMMARY

Implementations disclosed herein relate to utilizing generative model(s) (“GM(s)”) in generating, updating, and/or executing a user routine (e.g., that defines one or more device actions and/or one or more application actions to be routinely performed, etc.) that is personalized for a user (also referred to herein as “routine” for the sake of brevity). In various implementations, the routine can include one or more actions to be routinely performed via one or more devices and/or one or more applications. In various implementations, the routine can be generated using a generative model (e.g., a large language model (LLM) or other GM), based on processing user input indicating a user routine (e.g., by specifying actions to be routinely performed) as well as metadata associated with a list of devices and/or applications to which the user has access, and optionally capabilities thereof. Notably, a subset of the devices and/or applications can be selected, based on output generated using the generative model, to perform the one or more actions in furtherance of the user routine. Put another way, the user input can describe a desired user routine, or desired goal(s) and/or desired output(s) that require a user routine, and the generative model can be utilized to select the devices and/or applications capable of performing actions in furtherance of the user routine even though the user input does not explicitly describe the user routine or any of the devices and/or applications that are utilized in subsequently executing the user routine.

In some implementations, the routine can be updated or adjusted in response to detecting an additional user input that modifies the user routine. For instance, the user may previously mentioned an action to be routinely performed (e.g., “decrease screen time while I'm at home”), and the routine generated using the system disclosed herein can include a daily recommendation to limit screen time on the user's mobile device while the user is physically located at home, and/or to limit screen time on the user's smart TV while the user is physically located at home. Notably, these devices (e.g., the user's mobile device, smart TV, etc.) can be identified by the generative model even if the user input does not identify these devices or even if the user input does not include an explicit indication that these devices are present at the user's home. Further, if the user accesses the mobile device and/or the smart TV, the user can be notified of the desire to decrease screen time. Assuming the user does, in fact, decrease screen time, computational, network, and/or battery resources can be conserved at these devices in this example. Moreover, if the user subsequently provides additional user input of “don't let me watch any TV during weekdays”, the routine can be updated to disable any smart TVs in the user's home during the weekdays.

In some implementations, the routine can be updated or adjusted in response to a change in an environment of the user (e.g., adding or removing Internet-of-Things (IoT) device(s), installing or uninstalling application(s), etc.). For instance, in response to detecting that a new smart TV is added to the user's ecosystem of home devices after a device routine (e.g., determined based on the aforementioned user input of “decrease screen time while I'm at home”) was initially established, the device routine can be updated to include a device action that routinely limits screen time on the new smart TV. In case the additional user input of “don't let me watch any TV during weekdays” is received and the device routine has been modified based on the additional user input, the device routine can be updated to disable the new smart TV in the user's home during the weekdays in response to detecting the new smart TV.

In some implementations, the routine can be updated or adjusted in response to detecting a pattern of actions or activities deviating from the user routine to a certain degree. For instance, in response to detecting a user ignoring the notifications to reduce screen time (e.g., ignores 4 out of 5 notifications), the device routine can be updated to reduce the frequency that reminds the user to reduce screen time in an effort to conserve computational resources that are consumed in generating and rendering the reminders (e.g., from an interval of 30 minutes to an interval of 60 minutes or the like). It is noted that descriptions of generating or updating the user routine and/or content associated with the routine is not limited herein.

As another working example, a user may provide user input such as “I want to wake up at 5:00 AM, meditate, and work out before work”. In this working example, the user input can indicate a user routine by including a plurality of actions (e.g., “wake up at 5:00 AM”, “meditate”, and “work out before work”) to be routinely performed. In response to receiving such user input, smart devices and applications to which the user has access can be scanned to select one or more smart devices (and/or applications) to perform device actions (and/or application actions) in executing the device routine that supports the user routine. Optionally, in some implementations, the user input (e.g., “I want to wake up at 5:00 AM, meditate, and work out before work”) and metadata associated with the smart devices and applications to which the user has access can be processed, using a generative model (e.g., a large language model, “LLM”), to generate model output. The generative model can be so trained or fine-tuned that the model output generated based on the aforementioned user input and the aforementioned metadata can be processed to derive routine content (also referred to as “a routine description”, etc.) of the device routine that includes identifiers of the one or more smart devices (and/or applications) selected from all smart devices and applications to which the user has access. The routine content can additionally include the device actions (and/or application actions) performable using the selected one or more smart devices (and/or applications) to facilitate the user in developing and maintaining the user routine.

Optionally, a user schedule (and/or other user information, such as user location) can be processed (if with user permission) along with the aforementioned user input (e.g., “I want to wake up at 5:00 AM, meditate, and work out before work”) and the aforementioned metadata for the smart devices and applications to which the user has access, using the aforementioned generative model, to generate the model output. In this case, the routine content derived from the model output can additionally include a specific time (or time slot) to execute the device actions (and/or application actions) via the selected one or more smart devices (and/or applications).

Continuing with the working example above, the one or more selected smart devices (and/or applications) can include, for instance, a smart coffee maker, a smart clock (or an alarm application, depending on appliances or services the user has access to), a smart speaker, and a smart treadmill. In this working example, the device actions (and/or application actions) of the device routine performable by the selected smart devices (and/or applications) can include, for instance, a first device action that corresponds to the smart coffee maker starting at 4:55 AM, a second device action that corresponds to the smart clock to sound at 5:00 AM, a third device action that corresponds to the smart speaker playing meditation music at 5:15 AM, and a fourth device action that corresponds to the smart treadmill starting operation at 5:45 AM.

Optionally, the routine content derived from the model output can include one or more smart devices or applications to monitor. For instance, given the user input of “I want to watch less TV and read more books”, the device activities or status of the smart TV that the user has access to can be monitored. In some implementations, an alert (e.g., “Hey, you may be watching too much TV for the day. Let's stay on track for your goal of watching less TV.”) can be generated and rendered to the user to remind the user to watch less TV, in response to the smart TV being used for a predefined amount of time (e.g., 2 hours, etc.), where the predefined amount of time can be included in the routine content that is derived from the model output or can be specified in the user input (or other user data), etc. Alternatively, or additionally, a message can be generated and rendered to the user to direct the user to read a book instead of watching the TV, in response to the smart TV being turned on or used for the predefined amount of time. The message, for instance, can include a statement of a relevant user goal (e.g., “Let's keep reading more books and less TV”), and can include a link that, when selected, causes a smart reading device (or a reading application) to be launched in a specific state where a specific page of a book that the user left when reading last time is displayed (or in a specific state where an article determined based on a latest user's interest in astronomy can be displayed).

Optionally, the routine content can be re-generated using the generative model (or can be modified without using the generative model) in response to receiving additional user input that includes an additional action to be routinely performed (e.g., “Also take a 10-min walk during lunch hours”). Optionally, the routine content can be re-generated using the generative model (or can be modified without using the generative model) in response to receiving additional user input that includes an existing action (e.g., “I want to wake up at 6:00 AM instead” vs. “I want to wake up at 5:00 AM” in the previous user input) to be modified for routine performance. Optionally, the routine content can be re-generated using the generative model (or can be modified without using the generative model) in response to receiving additional user input that includes an existing action to be removed (e.g., “no more work out before work”), etc. In some implementations, a confirmation message can be configured to pop up to receive user confirmation from the user in removing an existing action, before having the existing action removed to update the routine content customized for the user.

In various implementations, a computer-implemented method is provided. The method includes: receiving, via a computing device and from a user of the computing device, a first user input indicating a user routine. The first user input, for instance, can include a plurality of keywords each corresponding to an action. As another example, the first user input can include a file (e.g., a published article, a webpage, a video, an audio file, etc.) describing a shared routine shared by an additional user. As a further example, the first user input can include a link to a file describing a shared routine shared by an additional user. It is noted that the first user input may not include any device and may not include any application (or any identifier thereof). The first user input may also not include any specific time or time duration associated with the user routine.

In various implementations, the method can further include: selecting, based on processing at least on the first user input indicating the routine, one or more Internet of Things (IoT) devices from a plurality of Internet of Things (IoT) devices to which the user has access. In various implementations, the method further includes: configuring the one or more IoT devices for routinely performing one or more actions facilitating the user routine.

In some implementations, the method further includes: selecting the one or more IoT devices based on processing the first user input and metadata associated with the plurality of IoT devices to which the user accesses, using a generative model. For instance, content (that is based on both the first user input and metadata associated with the plurality of IoT devices to which the user accesses) can be processed as input, using the generative model, to generate a first model output from which first routine content can be derived. The first routine content can include identifiers of the one or more IoT devices selected from the plurality of IoT devices to which the user accesses. Additionally, or alternatively, the first routine content derived from the model output can include the one or more actions to be routinely performed by the one or more IoT devices to facilitate the user routine.

In various implementations, the method can further include: causing the one or more IoT devices to routinely perform the one or more actions. In some implementations, the system can cause a first IoT device from the one or more IoT devices to perform a first action that initiates the user routine in response to a location of the user being within a predefined distance with respect to the first IoT device.

In various implementations, the method can further include: causing one or more calendar slots to be populated in a calendar application with reminder content that reminds the user to routinely perform one or more activities, where the reminder content can be determined based on the user input that indicates the user routine. For example, in various implementations, the first user input can include one or more actions to be routinely performed as part of the user routine. In this case, the system can further cause one or more calendar slots to be populated in a calendar application with respective reminder content each reminding the user to perform one of the one or more actions specified in the first user input.

In various implementations, additionally, or alternatively, the method further includes: configuring an alarm application to create an alert that specifies a starting time and/or an ending time for a particular action specified in the first user input, where the alert includes alert content alerting the user to perform the particular action. In some of the various implementations, the alarm application renders the alert at the specified starting time, as part of the user routine. In some of the various implementations, the alert content identifies a link to media content.

In various implementations, additionally, or alternatively, the method further includes: configuring an assistant application to monitor activities (e.g., launch, log-in, add items to a shopping cart, check out an order, etc.) of one or more applications or services that the user has access to. For instance, the assistant application can monitor a food-ordering application based on the first user input indicates a goal (or an action) of “eating healthier”, and in response to detecting the food-ordering application being accessed by the user, generate a recommendation that recommends a restaurant for ordering healthy food (or that recommends a healthy meal and a list of restaurants that offers the healthy meal). The recommendation can be rendered via a client device of the user. Optionally, the recommendation can be rendered as a pop-up message with respect to a user interface of the food-ordering application.

In various implementations, the method further includes: determining whether the one or more actions have been routinely performed to facilitate the user routine; generating a report reporting whether the one or more actions are performed to facilitate the user routine; and causing the report to be rendered to the user.

In various implementations, the method further includes: receiving additional user input that modifies the user routine; and in response to receiving the additional user input that modifies the user routine, updating a selection of the one or more IoT devices in accordance with the modified user routine. In some of the various implementations, the selection of the one or more actions is updated by adding (or deleting) a particular IoT device to the one or more IoT devices.

In various implementations, the method further includes: receiving additional user input that modifies the user routine; and in response to receiving the additional user input that modifies the user routine, modifying the one or more actions to be routinely performed using the one or more IoT devices in accordance with the modified user routine.

In various implementations, the method further includes: receiving a second user input specifying a particular action.

In various implementations, the method further includes: determining that the second user input specifying the particular action is to modify the user routine indicated by the first user input. In some of the various implementations, the method can include: processing content based on (1) the first user input, (2) the second user input, and (3) metadata associated with a list of devices and applications to which the user has accesses, as input, using the generative model, to generate a second model output from which second routine content is derived. The second routine content can include an updated list of IoT devices to perform one or more updated actions that facilitate the modified user routine.

In various implementations, the method further includes: configuring the updated list of IoT devices to perform the one or more updated actions that facilitate the modified user routine.

In various implementations, by properly training or fine-tuning the generative model in determining one or more device actions (and/or application actions) to be performed as a routine to stimulate or enable the user to routinely perform one or more desired actions, time and resources spent in repeated determining a specific time and duration to control IoT devices and application for a corresponding function can be saved or reduced. The more complicated the user input (which describes the actions to be routinely performed), the more the saved time and resources in having routine content of a routine generated using the generative model. The routine content generated using the generative model can also be more comprehensive and have less or no conflict if user schedule or other metadata associated with the user is provided, which can hardly be possible with manual effort.

The preceding is presented as an overview of only some implementations disclosed herein. These and other implementations are disclosed in additional detail later in this disclosure. The disclosure can also include other implementations. For instance, while the preceding is presented with respect to IoT devices, instead of or in addition to the IoT devices, a plurality of applications the user has access to can be determined, and metadata associated with the plurality of applications can be processed, along with the first user input, using a generative model, to determine routine content that includes one or more applications selected from the plurality of applications, to perform one or more application actions that facilitates the user routine. The present disclosure is not limited thereto.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example scenario where a routine is generated in response to receiving user input(s), in accordance with various implementations of the present disclosure.

FIG. 1C illustrates another example scenario where a routine is generated in response to receiving user input(s), in accordance with various implementations of the present disclosure.

FIG. 2A illustrates a user interface of an assistant application showing a plurality of categories of actions to be routinely performed, for selection by a user, in accordance with various implementations of the present disclosure.

FIG. 2B illustrates an example of routine content visualized at a user interface of a client computing device in response to receiving user input indicating a list of actions to be routinely performed, in accordance with various implementations of the present disclosure.

FIG. 2C depicts an example of a notification, in accordance with various aspects of the present disclosure.

FIG. 3A depicts an example of a method for generating a routine (e.g., device routine), in accordance with various aspects of the present disclosure.

FIG. 3B depicts an example of a method for updating a routine, in accordance with various aspects of the present disclosure.

FIG. 4A depicts a flowchart illustrating an example method of training one or more generative models, in accordance with various aspects of the present disclosure.

FIG. 4B depicts a flowchart illustrating another example method of generating a routine using one or more generative models, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It is appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

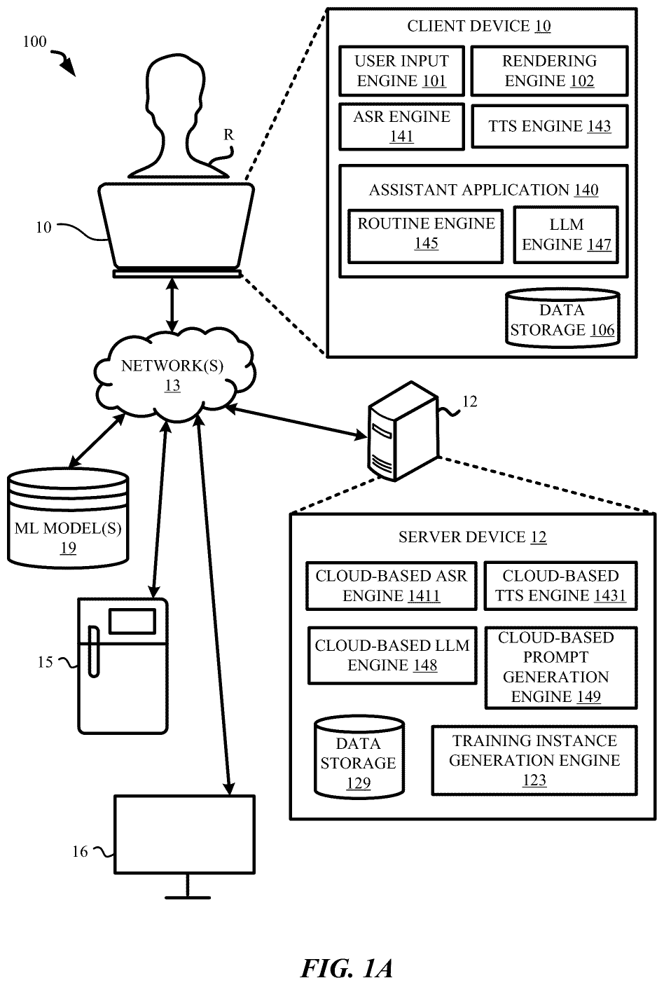

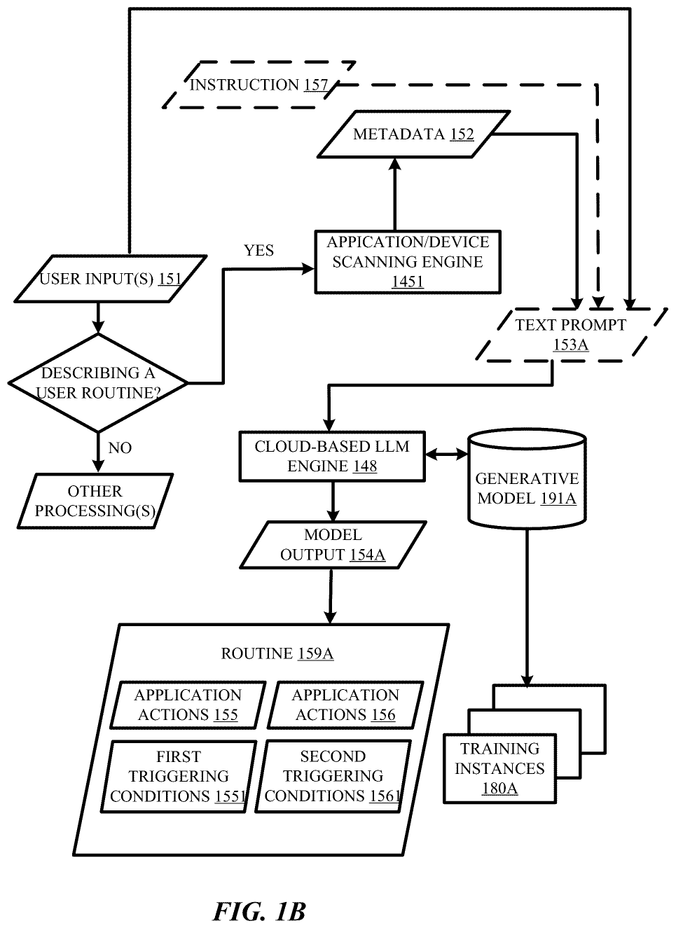

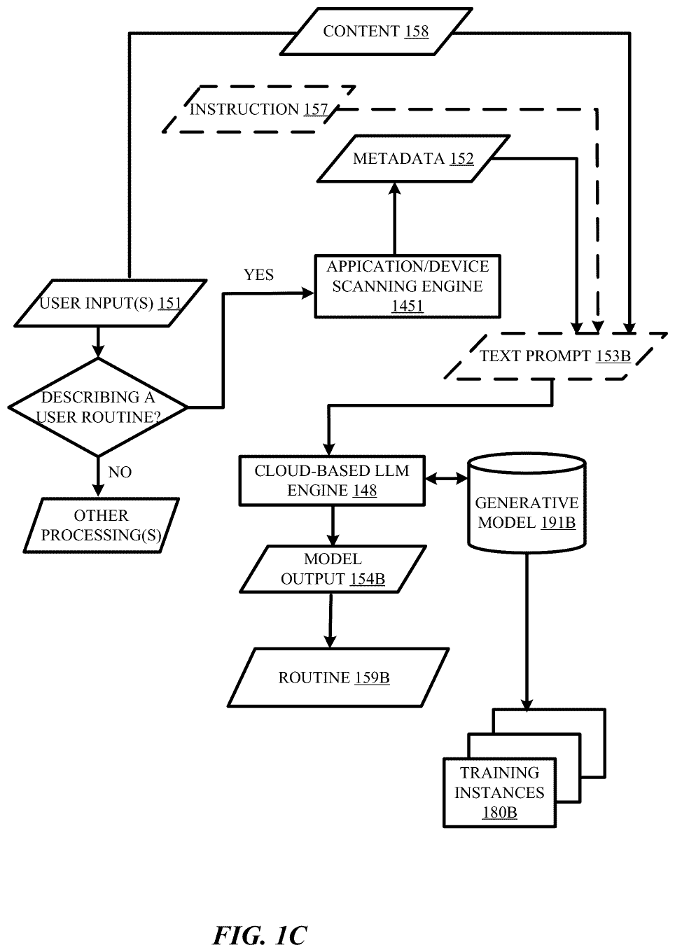

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”) that is in communication with a server computing device 12 (“server device”). The client computing device 10 can be in communication with the server computing device 12, via one or more networks 13. The one or more networks 13 can include, for example, a local area network (LAN), a wide area network (WAN) such as the Internet, and/or any other appropriate network.

In some implementations, the environment 100 can be an office environment, a home environment, a lab environment, or any other applicable environment, and can include additional device(s) in communication with the client computing device 10 (or the server computing device 12). The additional devices can include one or more Internet-of-things (IoT) devices being part of a network of physical devices that are embedded with sensors, software, and other components to enable data collection and/or processing, where the network of physical devices can be interconnected (e.g., via Bluetooth®, the Internet, wide area network, etc.) to share data. The one or more IoT devices can include, for instance, a kitchen appliance (a fridge 15 in FIG. 1A, a dishwasher, a microwave, etc.), a vehicle, a thermostat, a monitor, etc. The additional devices can, additionally, or alternatively, include one or more smart devices. A smart device may include, or otherwise access, one or more machine learning (ML) models, and can be, for instance, a stand-alone smart speaker, a smart watch, a smart TV (e.g., 16 in FIG. 1A), or a smart in-vehicle entertainment system, etc. A smart device may, or may not be, an IoT device. The client computing device 10 can be a primary control device and can be, for instance, a smart device, or an IoT device.

In some implementations, the client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

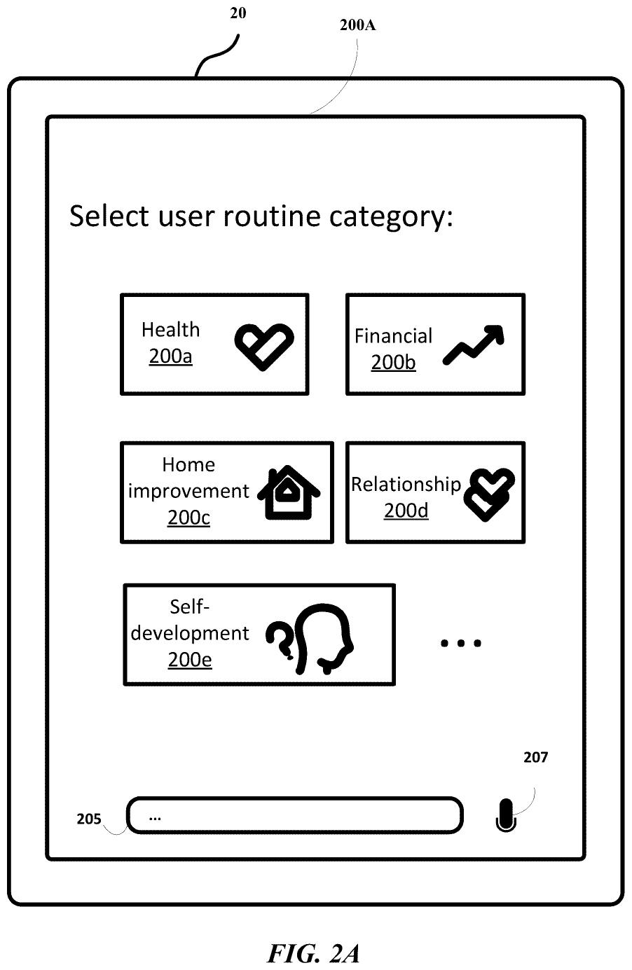

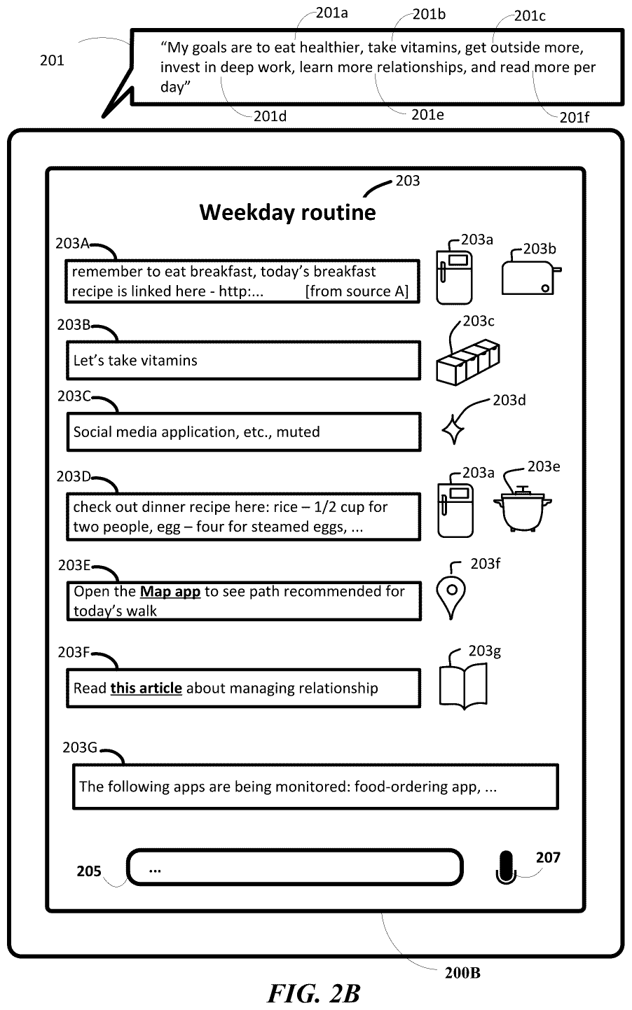

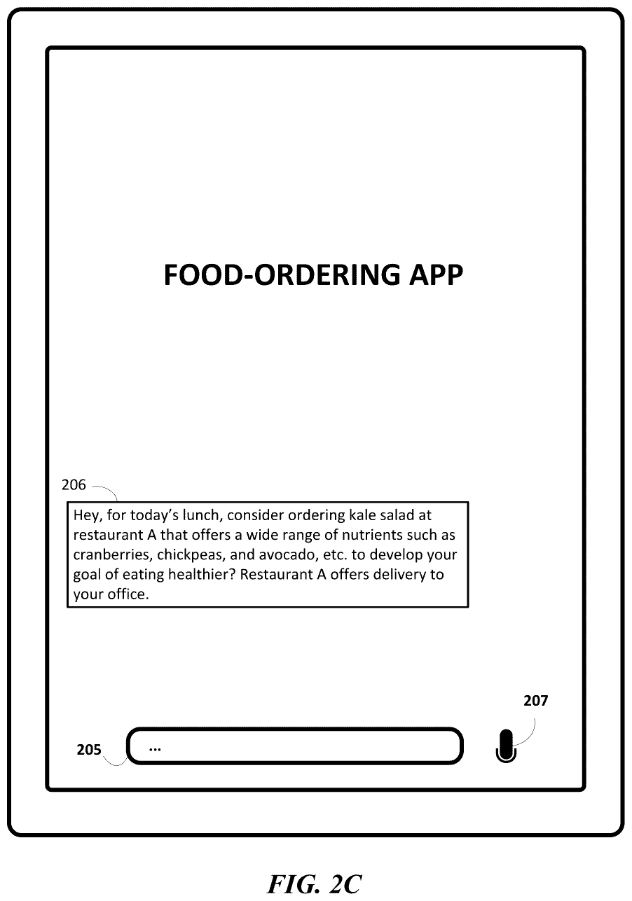

In various implementations, the client computing device 10 can include a user input engine 101 that is configured to detect user input provided by a user (e.g., user R) of the client computing device 10. The user input may be provided by the user using one or more user interface input devices, such as a keyboard, a touch screen, a microphone, etc. The user input can be typed input, touch input, audible input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. The typed input can be received, for instance, via an input field (e.g., 205 in FIG. 2A) of a graphical user interface (GUI). Additionally, or alternatively, the client computing device 10 can be equipped with one or more microphones that capture audio data, such as audio data capturing spoken utterances of the user and/or other sounds in an environment of the client computing device 10. Optionally, the audio data capturing the spoken utterances can be received in response to a user selecting an icon (e.g., 207 in FIG. 2A) indicating recording of audio data. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the client computing device 10 can include a rendering engine 102, one or more applications installed locally at, or otherwise accessible via, the client computing device 10, and/or a data storage 106. In various implementations, the rendering engine 102 can be configured to provide content for audible and/or visual presentation to a user of the client computing device 10 using one or more user interface output devices. For example, the client computing device 10 can be equipped with one or more speakers that enable content (e.g., “Here are some latest astrology podcasts that you might be interested in”) to be provided for audible presentation to the user via the client computing device 10. Additionally, or alternatively, the client computing device 10 can be equipped with a display or projector that enables content (e.g., “Great job! you've walked 9,000 steps today, just walk another 10 min for 1,000 more steps”) to be provided for visual presentation to the user via the client computing device 10.

The data storage 106, and/or a data storage 129 at the server device 12, can store various types of files and/or data. For instance, the data storage 106 can store metadata (e.g., a user profile of user R, etc.) associated with the one or more applications and/or associated with the client computing device 10. Additionally, or alternatively, in some implementations, the data storage 106 (or the data storage 129) can store a plurality of training instances (e.g., 180A and 180B in FIG. 1B/1C) to train or fine-tune machine learning (ML) model(s) 19. In some implementations, the ML model(s) 19 can include a generative model. The generative model can be, for instance, a large language model (“LLM”) or other multi-modal generative model(s) such as Gemini, GPT, etc.

In some implementations, training of the generative model (e.g., LLM) can be performed through supervised learning and/or reinforcement learning. The reinforcement learning can be, for instance, reinforcement learning from human feedback (“RLHF”) that incorporates human feedback into the training of the LLM to align output of the LLM with human preferences, e.g., respond to user input that is explicitly or implicitly directed to a virtual assistant that utilizes the LLM to generate responsive content and not respond to user input that is explicitly or implicitly directed to other human user(s) in a multi-user conversation. This can be implemented using a trained reward model. For instance, for a given user input and a plurality of responses responsive to the given user input, a human reviewer can indicate a preference (e.g., in the form of a scalar score) for each of the plurality of responses. In other words, the plurality of response for the given user input can be ranked in an order from highest human preference (indicated by a highest scalar score) to lowest human preference (indicated by a lowest scalar score). In some implementations, the scalar scores assigned by the human reviewer to the plurality of responses for the given user input can satisfy a Gaussian distribution with an average value of approximately “0”, where the scalar score(s) for response(s) of higher human preference should be positive and increase with the increasing of human preference and the scalar score(s) for response(s) of lower human preference should be negative and decreases with the decreasing of human preference.

The scalar score can be applied as a reward in the RLHF process, where a large value of the scalar score indicates a higher quality of a corresponding response more preferred by the human reviewer and a lower value of the scalar score indicates a higher quality of a corresponding response that is less preferred by the human reviewer. In some implementations, such given user input and the plurality of responses responsive to the given user input can be stored in the data storage 106 (or the storage 129) as one instance for training the generative model. In some implementations, a small quantity of instances can be manually curated and/or stored in the data storage 106, to train the generative model.

In some implementations, the one or more applications can include an assistant application 140, a social media application, a video player, a search application, a note-taking application, a shopping application, a messaging application, and/or any other appropriate applications installed at, or accessible via, the client computing device 10. In some implementations, the assistant application 140 can be in communication with the ML model(s) 19 or a portion thereof (e.g., the aforementioned generative model).

In various implementations, optionally, the client computing device 10 can further include a plurality of local components. The plurality of local components can include, for instance, an automatic speech recognition (ASR) engine 141 and/or a text-to-speech (TTS) engine 143. In some implementations, the ASR engine 141 and/or the TTS engine 143 may be, but does not necessarily need to be, included in the assistant application 140. However, it should be understood that in various implementations, the ASR engine 141 and/or the TTS engine 143 may be omitted and the generative model itself may be capable of processing speech inputs and generating audible outputs. In some implementations, a user (e.g., user R) of the client computing device 10 may have a registered account associated with the assistant application 140, or other application(s). In some implementations, additionally or alternatively, the plurality of local components at the client computing device can include other component(s) such as a routine engine 145, and/or an LLM engine 147. The routine engine 145 and/or the LLM engine 147 can be included, for instance, in the assistant application 140.

In some implementations, the ASR engine 141 (and/or a cloud-based ASR engine 1411) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 141 and/or 1411 can select one or more of the ASR hypotheses as corresponding recognized text (“transcript”) that corresponds to the spoken utterance(s) (e.g., selected based on the corresponding predicted measures).

The TTS engine (e.g., 143 and/or 1431) can process, using TTS model(s), corresponding streams of textual content (e.g., content generated based on LLM or a predetermined text, etc.) to generate synthesized speech audio data that includes computer-generated synthesized speech. In additional or alternative implementations, the synthesized speech audio data can be pre-cached in memory or in one or more databases accessible by the client computing device 10.

In some implementations, the routine engine 145 can be configured to recommend one or more application actions to determine an application routine and/or one or more devices to determine a device routine (may be referred to shortly and collectively as “a routine”). In some implementations, additionally, or alternatively, the routine engine 145 can be configured to modify the routine, for instance, by updating one or more application actions that are included in the routine.

In some implementations, the routine engine 145 can recommend one or more application actions to determine a routine, in response to receiving a user input. In some implementations, the user input can include one or more keywords (e.g., indicating a desired routine) that triggers the routine engine 145 to generate the routine. As a non-limiting example, the user input can be an audible user input such as “Assistant, I want to eat healthier.” In this example, the one or more keywords that triggers the routine engine 145 to determine a routine can be “eat healthier.”

In some implementations, in response to the user input including one or more keywords (e.g., “eat healthier”) that triggers the routine engine 145 to determine a routine, the routine engine 145 can retrieve metadata of applications and/or devices that a user of the user input has access to. The metadata associated with the applications and/or devices can be processed to determine the one or more application actions to form the routine, where the one or more application actions can be performed via the applications or the devices (e.g., one or more IoT devices from the network of IoT devices that the user has access to). In some implementations, the routine engine 145 can determine the time at which each of the one or more application actions and/or device actions are to be performed. In case the user has access to a calendar application, the routine engine 145 can generate one or more entries in the calendar application based on the time determined for each of the one or more application actions.

For instance, continuing with the non-limiting example above, in response to receiving the user input of “I want to eat healthier” from user R, the routine engine 145 can scan a list of applications and/or devices that user R has access to, where the list of applications and/or devices can include an assistant application (not always required), a smart fridge, a smart rice cooker, a food-ordering application, a smart thermostat, a smart air fryer, and a security camera. Based on scanning the list of applications and/or devices, the routine engine 145 can select one or more applications and/or devices from the list to recommend one or more application actions associated with the user input of “I want to eat healthier”.

In the non-limiting example above, the one or more applications and/or devices selected by the routine engine 145 based on the user input of “I want to eat healthier” can include: the smart fridge, the smart rice cooker, the food-ordering application, and the smart air fryer. The one or more application actions performable via the applications or the devices can include, for instance, assistant application action(s) that determine a time to recommend a recipe, request food information of food available in the smart fridge within a short period before the determined time to recommend the recipe, determine the recipe based on the food available in the smart fridge when the food information is requested, and cause the determined recipe to be recommended at the determined time. The time (e.g., 5:00 PM) to recommend the recipe can be determined based on time slot(s) associated with one or more entries of the calendar application indicating a dinner time (e.g., 5:30 PM to 6:00 PM) for the user on weekdays. The time to recommend the recipe can, additionally or alternatively, be determined based on metadata of the smart rice cooker (or other smart cooking appliances such as the smart air fryer) indicating a specific time (or time period) the user frequently uses the smart rice cooker.

In some implementations, the recipe can be determined by the LLM engine 147 using a generative model (e.g., the LLM). Continuing with the non-limiting example above, a text prompt can be generated based on the user input of “I want to eat healthier” and a list of ingredients available in the smart fridge, where the text prompt can include an instruction to generate a recipe based on the user input and the list of ingredients available in the smart fridge. Optionally, the text prompt can further include the dinner time for the user on weekdays and/or a location of the user. The location of the user, for instance, can be determined using a GPS, a smart home device, or other devices or service, with user permission. The text prompt can be processed, using the generative model, to generate model output from which the recipe to recommend to the user is derived. In some implementations, the generative model can be so trained or fine-tuned that the user input of “I want to eat healthier” and the list of ingredients available in the smart fridge can be processed using the generative model, instead of the text prompt which includes the instruction to generate a recipe and the list of ingredients available in the smart fridge, to generate model output from which the recipe is determined.

In some implementations, the routine engine 145 can generate an entry in the calendar application for the recommended recipe, where the entry includes the recommended recipe in a body of the entry, or include the recommended recipe as an attachment. In some implementations, the routine engine 145 can cause the recommended recipe to be rendered via a display selected via one or more displays the user has access to, e.g., a display in the kitchen area.

Continuing with the non-limiting example above, the one or more application actions performable via the applications or the devices can, additionally or alternatively, include, smart fridge action(s) such as generating a beep at, or prior to, the dinner time of the user, to remind the user of checking out the ingredient in the smart fridge. The smart fridge action(s) can additionally, or alternatively, include rendering the recipe generated using the generative model via a screen of the smart fridge, e.g., at the aforementioned time (e.g., 5:00 pm) to recommend the recipe.

Continuing with the non-limiting example above, the one or more application actions performable via the applications or the devices can, additionally or alternatively, include, one or more smart rice cooker actions including, e.g., turning on the smart rice cooker at a designated time determined based on the dinner time of the user, if a pot of the smart rice cooker is detected to be not empty (e.g., the pot is filled with ingredients such as rice and water). The one or more smart rice cooker actions can, alternatively, include a notification (e.g., message, sound) to remind the user to use the smart rice cooker to cook rice in case rice is listed as part of the recipe. The way the notification is provided can depend on several factors such as whether the user is within a predefined distance (e.g., in the same room, less than 5 meters, etc.) with respect to the smart rice cooker. For instance, if the user is detected to be in the kitchen where the smart rice cooker sits, the notification can be a rice cooker beep reminding the user to use the rice cooker to cook the recipe generated using the LLM. Additionally, or alternatively the rice cooker can be automatically turned on.

Continuing with the non-limiting example above, the one or more application actions performable via the applications or the devices can, additionally, or alternatively, include, one or more smart air fryer actions including, e.g., configuring the smart air fryer with settings such as a desired cooking mode (e.g., roast, etc.), a desired temperature (e.g., 375 F), and a desired cooking duration (e.g., 20 minutes) to cook the recipe (or a portion thereof). The one or more smart air fryer actions can, additionally or alternatively, include a notification (e.g., message, sound) to remind the user to use the smart air fryer to cook food listed in the recipe (or listed as part of the recipe). The way the notification is provided can depend on several factors such as whether the user is within a predefined distance (e.g., in the same room, less than 5 meters, etc.) with respect to the smart air fryer. For instance, if the user is detected to be in the kitchen where the smart air fryer sits, the notification can be an air fryer beep reminding the user to use the air fryer to cook the recipe generated using the LLM. Additionally, or alternatively the air fryer can be automatically turned on.

In some implementations, the user can be informed of the routine that includes the one or more application actions determined based on the user input (e.g., “I want to eat healthier”), and can be provided with options to accept, deny, or modify the routine. Optionally, the execution of the routine can be in response to receiving additional user input that accepts/confirms the routine. Optionally, in response to receiving the additional user input that accepts the routine, the assistant application 140 can be configured to monitor activities of the food-ordering application. For example, in response to detecting that the food-ordering application is launched, the assistant application 140 can remind the user of the recommended recipe, or can recommend a restaurant best known for providing healthy meals. In some implementations, if the user continues to browse a specific restaurant using the food-ordering application, the assistant application 140 can recommend a healthy meal to order from the restaurant or recommend another restaurant that is considered healthier.

As another example, the user may have a New Year's resolution to reduce their social media screen time, to increase knowledge of astrology, and to spend more time outside. In this example, the system can determine to monitor social media applications that the user has access to, based on a user input of the user that describes the New Year's resolution. In response to detecting user activity of the user indicating a usage of a particular social media application for over an hour (or other amount of time), the system can generate and send a notification to the user. The notification can be, for instance, “Hey, how about checking out this podcast about recent trends in astrology? Here is a 30-minute walking route on the Map application you can take while listening”. Such notification can be triggered by action detected to be deviating from the New Year's resolution, and content of the notification can be determined based on the New Year's resolution and an environment of the user.

In some implementations, the routine, after being executed, can be modified based on further user input(s). For instance, the user may provide further user input, such as, “remind me to drink milk in the morning”. In this case, the assistant application 140 can determine that the further user input is associated with the routine corresponding to “eat healthy”, and in response, determine one or more additional application actions to add to the routine that corresponds to “eat healthy”. The one or more additional application actions can include, for instance, an assistant action of reminding the user to drink milk via a message or audible notification of the assistant application 140, a smart fridge action of reminding the user to drink the milk in the smart fridge (e.g., via a display of the smart fridge if it has a display, or via a speaker of the smart fridge, etc.) or to purchase milk if the smart fridge is out of stock of any milk, etc.

As another example, the user may provide further user input, such as, “eat more salmon”. In this case, the assistant application 140 can determine that the further user input is associated with the routine corresponding to “eat healthy” (which can be a previous user input that triggers generation of the routine), and in response, can determine to modify the routine that corresponds to “eat healthy”. For instance, the assistant application 140 can cause the smart fridge to generate a notification to remind the user to purchase salmon if the smart fridge is out of stock of salmon. In some implementations, the assistant application 140 can search to determine a frequency to eat salmon. For instance, the assistant application 140 can recommend a frequency of eating salmon twice or three times a week. In some implementations, in addition to information indicating the ingredient available in the smart fridge and the user input of “I want to eat healthier”, information such as recipe(s) so far adopted by the user within a predefined past period (the past three days, the past week, the past days within the week, etc.), the further user input of “eat more salmon”, and/or the recommendation of eating salmon twice or three times a week, can also be processed using the generative model in determining the recipe.

In some implementations, the assistant application 140 can generate a weekly report that reports user activity in association with the routine generated for a user input of “eat healthier”. For instance, the assistant application 140 can cause one or more selectable graphical user interface (GUI) elements to be rendered to the user to receive user input confirming whether one or more daily user activities (e.g., cook a meal using a recipe recommended based on utilizing the generative model, etc.) associated with the routine of “eat healthier” is completed. The weekly report can include statistics showing a fulfillment rate indicating a frequency of fulfillment of user activities that are associated with the routine corresponding to “eat healthier”. For example, if the user confirms that three recipes generated using the generative model and recommended by the assistant application 140 were cooked during the past week, the weekly report for the routine of “eat healthier” can indicate that a fulfillment rate of 60% is achieved since the user confirms three meals cooked using daily recipe recommendation recommended for the weekdays, out of the five daily recipes recommended by the assistant application 140.

In various implementations, the generative model can be a large language model (LLM) having less than 100 billion parameters, more than 100 billion parameters, or over 200 billion parameters, etc. The greater the number of parameters of an LLM, the more complex (or sophisticated) a task (e.g., specified in a user query or request) the LLM can theoretically handle. The LLM may be stored at client computing device 10, or at the server computing device 12. For instance, if the memory of the client computing device 10 restricts the storing of the LLM at the client computing device 10 or if a length of a textual prompt to be processed using the LLM exceeds a predetermined token length, the LLM may be stored at the server device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, when a generative model (e.g., 191A) is stored at the client computing device 10, the maximum token length of content (e.g., text) processable using the LLM may be a first maximum token length (e.g., 10,000). In some implementations, when the generative model (e.g., 191B) is stored at the server device 12, the maximum token length of content (e.g., text) processable using the generative model may be a second maximum token length (e.g., 30,000, 100,000, 1 million, etc.) that is greater than the first maximum token length. The maximum token length can be a maximum number of tokens (which can be parsed from a user input) that is allowed for processing, in a single iteration, using the generative model.

In some implementations, the LLM can be transformer-based. One non-limiting example of an LLM is GOOGLE'S Pathways Language Model (PaLM). Another non-limiting example of an LLM is GOOGLE'S Language Model for Dialogue Applications (LaMDA). Another non-limiting example of an LLM is GOOGLE'S Gemini suite of LLMs.

It is noted that while the user input in the non-limiting example above is illustrated to include a to-be-routinely-performed action of “eat healthier”, the user input can include or specify more than one action to be routinely performed. For example, in some implementations, the user input can be an utterance describing a series of actions to be routinely performed. The user input can be, for instance, “I want to eat healthier and read more”.

The server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 10. For example, the server computing device 12 can include a cloud-based ASR engine 1411, a cloud-based TTS engine 1431, a cloud-based prompt-generating engine 149, and/or a cloud-based LLM engine 148. The cloud-based prompt-generating engine 149 can be configured to generate a text prompt based on user input (e.g., “eat more salmon”), where the text prompt is processable using one or more ML models described in this disclosure. It is noted that, however, the one or more ML models can be so trained or fine-tuned that, instead of the text prompt, the user input (and/or the metadata) can be processable using the one or more ML models. In this case, the cloud-based prompt-generating engine 149 may not be needed.

In some implementations, the server computing device 12 can further include the training instance generation engine 123. The training instance generation engine 123 can be applied to generate training instances to train the aforementioned generative model (e.g., LLM 191A in FIG. 1B), and/or to generate instances to train the aforementioned reward model. As described above, the generative model can be trained, e.g., via RLHF using the reward model, to be capable of processing a user query considering a user intent that is parsed/determined from input event(s) associated with the user query.

FIG. 1B illustrates an example scenario where a routine is generated in response to receiving user input(s) 151, in accordance with various implementations of the present disclosure. For example, the user input(s) 151 can indicate a first action to be routinely performed and a second action to be routinely performed. The user input(s) 151 can be received at the client computing device 10 (e.g., via input devices such as microphone, a touch screen, a keyboard, etc.).

The user input(s) 151 can be, for instance, a submission of user selection of a first graphical user interface (GUI) element suggesting a first action to be routinely performed (e.g., “take vitamins”) as well as user selection of a second GUI element suggesting a second action to be routinely performed (e.g., “read more”). The user input(s) 151, as another example, can be a user utterance of “Assistant, I want to take vitamins and read more” or “Help me take vitamins and read more”, etc. As a further example, the user input(s) 151 can be two separate user utterances including a first user utterance of “take vitamins”, and a second user utterance of “read more”. As an additional example, the user input(s) 151 can be a typed user input at an input field of the assistant application 140, where the typed user input can be “I want to take vitamins and read more”. The user input(s) 151, however, are not limited to descriptions herein.

Optionally, in response to receiving the user input(s) 151 describing the first and second actions to be routinely performed, whether the user input(s) 151 is directed to the routine engine 145 to generate a routine can be determined. For instance, based on content of the user input(s) 151 indicating one or more actions to be routinely performed, the user input(s) 151 can be forwarded to the routine engine 145, to generate a routine (e.g., consisting of device actions and/or application actions that facilitate a user routine formed by the actions to be routinely performed). As another example, based on the user input(s) 151 being a typed user input received at an input field associated with a routine function of the assistant application 140, the typed user input can be determined as being directed to the routine engine 145, for a routine to be generated based on the typed user input.

The routine engine 145 can include an application/device scanning engine 1451 (an instance of which can also be implemented locally at the client computing device 110) that scans applications and devices (e.g., smart devices, IoT devices, etc.) the user has access to, to retrieve metadata 152 associated with the user's applications and the smart devices. In some implementations, the application/device scanning engine 1451 can scan the applications and the devices that the user has access to, in response to determining that the user input(s) 151 invokes the routine engine 145 to generate a routine. In some other implementations, the application/device scanning engine 1451 can scan the applications and the smart devices that the user has access to, in response to receiving the user input(s) 151, without determining whether the user input(s) 151 invoke the routine engine 145 to generate a routine. The metadata 152 associated with the applications can include, for instance, application data of the applications that describe functions and services of the applications, devices at which the applications are installed, smart devices controllable using the applications, activities of the applications, etc. The metadata associated with the devices can include, for instance, activities of the devices, device identifiers associated with the devices, capabilities associated with the devices, etc.

In some implementations, a text prompt 153A can be generated based on the user input(s) 151 and the metadata 152 that is associated with the applications and the smart devices. For instance, the text prompt 153A can include: the user input(s) 151 that indicates the first action to be routinely performed and the second action to be routinely performed, the metadata 152 associated with the applications and the smart devices that the user has access to, and optionally an instruction 157 to generate a routine using the user input(s) 151 and the metadata 152. The text prompt 153A can be processed, using a generative model 191A, to generate model output 154A from which the routine 159A can be generated. The generative model 191A can be so trained (e.g., using training instances 180A) that the routine 159A generated using the generative model 191A can include: a first list of application actions 155 (and/or first device actions) for the first action to be routinely performed; and a second list of application actions 156 (and/or second device actions) for the second action to be routinely performed.

Continuing with the working example above in which the first action to be routinely performed is “take vitamins” and the second action to be routinely performed is “read more”, the first list of application actions can include a first assistant action of notifying the user to take vitamins. In some implementations, the assistant application 140 can perform the first assistant action by popping up a message at a display of the client computing device 10 reminding the user to take vitamins, or by audibly rendering a voice message reminding the user to take vitamins, etc. The first list of application actions can, alternatively or additionally, include a smart pill organizer action, where an application that controls a smart pill organizer can perform the smart pill organizer action to remind the user to take vitamins that are stored in a particular compartment of the smart pill organizer.

The second list of application actions can include a second assistant action of notifying the user to read more. In some implementations, the assistant application 140 can perform the second assistant action by popping up a message at a display of the client computing device 10 reminding the user to read an article, or certain pages of an eBook, etc. The message can include a link to the article, or to a first page of the certain pages of the eBook. The second list of application actions can, alternatively, or additionally, include a reading application action, where a reading application can perform the reading application action to remind the user to read the article, or to read the certain pages of the eBook. Descriptions of the first (or second) list of application actions, however, are not limited herein.

In some implementations, the routine 159A can further include first triggering conditions 1551 that trigger one or more of application actions (or device actions) from the first list 155, and/or triggering conditions 1561 that trigger one or more application actions (or device actions) from the second list 156. Additionally, the first triggering conditions 1551 (or the second triggering conditions 1561) can include a triggering time (or time slot) at which a respective application action (or device actions) from the first list 155 (or from the second list 156) is triggered. In some implementations, the triggering time for one or more application actions (or device actions) can be determined based on metadata associated with the user. The metadata associated with the user can include a user profile listing user preferences (e.g., favorite food, etc.), calendar data from a calendar application of the user listing one or more events (e.g., a dinner invite) of the user, message data of one or more messaging applications of the user (which may include, e.g., a receipt of a food delivery order, a receipt of a book purchase order, a subscription of a social media channel), etc.

For instance, the aforementioned first assistant action of notifying the user to take vitamins (or the smart pill organizer action to remind the user to take vitamins that are stored in a particular compartment of the smart pill organizer) can be triggered at a triggering time (e.g., an hour prior to bedtime of the user which can be specified by the user) for the first assistant action (or the smart pill organizer action) in the routine 159A. Alternatively, or additionally, the aforementioned second assistant action that reminds the user to read an article (or the reading application action) can be performed at a triggering time (e.g., 7:00 am) for the second assistant action (or the reading application action) in the routine 159A. The second triggering time for the second assistant action can be, for instance, determined based on a user preference to read in the early morning and/or based on working hours of the user being between 8:00 AM to 5:00 PM (e.g., as indicated in a chat history of a chat between the user and a family member, etc.).

Additionally, or alternatively, the first triggering conditions 1551 (or the second triggering conditions 1561) can include a triggering location (or a triggering area) of the user (e.g., with respect to corresponding smart devices the user has access or control), where the user needs to be detected at the triggering location (or within the triggering area) for a respective application from the first list 155 (or from the second list 156) to be triggered. For instance, the first assistant action of notifying the user to take vitamins (or the smart pill organizer action to remind the user to take vitamins that are stored in a particular compartment of the smart pill organizer) can be triggered if (and sometimes only if) the user is within a proximity (e.g., at home, less than 5 meters, etc.) of the smart pill organizer that stores the vitamins.

In some implementations, the first list of application actions 155 (or device actions) and the second list of application actions 156 (or device actions) can be listed in the routine 159A in a temporal order determined based on the triggering times for the first list of application actions 155 (or device actions) and based on the triggering times for the second list of application actions 156 (or device actions).

In some implementations, the generative model 191A can be so trained that the text prompt 153 (or the instruction 157 to generate a routine using the user input(s) 151 and the metadata 152) is no longer needed. For instance, instead of the text prompt 153A, the user input(s) 151 and the metadata 152 may be processed as input, using the generative model 191A, to generate the model output 154 from which the routine 159A is derived.

In some implementations, the assistant application 140 can generate a user interface of the assistant application 140 to display the routine 159A, where the routine 159A can be visualized at the user interface rendered by the rendering engine 102. The routine 159A, when visualized, can include entries of the first list of application actions 155 (or device actions) and entries of the second list of application actions 156 (or device actions). The entries of the first list of application actions 155 (or device actions) can each include, for instance, a name (or other identifier, symbol, etc.) of a corresponding application action from the first list 155 (or device actions), a triggering time of the corresponding application action, a triggering location of the corresponding application action, etc. The entries of the second list of application actions 156 (or device actions) can each include, for instance, a name (or other identifier, symbol, etc.) of a corresponding application action from the second list 156 (or device actions), a triggering time of the corresponding application action, a triggering location of the corresponding application action, etc. Each entry of an application action or device action (from the first or second list) can further include, for instance, status content (e.g., a graphical icon, or word such as “completed”, “in progress”, “skipped”) indicating whether the application action is completed. The user interface may include options for selection by the user to view application actions forming the routine 159A based on categories of the application actions (e.g., whether an application action is associated with the first action to be routinely performed or second action to be routinely performed), or can view the application actions based on time at which the application actions are respectively scheduled. The user may also select to view application actions (or device actions) forming the routine 159A based on other factors, such as a location of the application action (or device action) to be performed, etc.

Optionally, the routine engine 145 can include a calendar entry generation engine that communicates with a calendar application of the user, or otherwise generates a message (or other signals) to cause the calendar application to generate one or more calendar entries. The calendar entry generation engine can create a plurality of calendar entries in the calendar application of the user for application actions (or device actions) from the first list 155 and/or the second list 156.

Optionally, the user can provide a subsequent user input to add a third action to be routinely performed, to modify the first or second action to be routinely performed, etc. For instance, the subsequent user input can be, “get outside more”, that mentions a third action to be routinely performed. As another example, the subsequent user input can be, “take more vitamin C” that modifies the first action to be routinely performed (e.g., “take vitamins”) or “read more psychology” that modifies the second action to be routinely performed (e.g., “read more”).

In some implementations, the subsequent user input, the routine 159A (or 159B), and/or the applications and smart devices available to the user, can be processed using the generative model 191A, to generate additional model output from which an updated routine can be derived.

In some implementations, referring to FIG. 1C, the user input(s) 151 can be a submission (e.g., upload) of a text file (e.g., an article introducing a routine shared by an additional user), an audio file, a link to a webpage (or podcast) introducing activities repeated as a routine (e.g., on a daily basis, routinely performed on weekdays or weekends), etc. In this case, the content 158 of the text file (or the audio file, or the webpage, podcast, etc.) and/or the aforementioned metadata 152 associated with the applications and the smart devices (that the user has access to), or a text prompt 153B derived therefrom, can be processed as input, using the generative model 191B, to generate model output 154B from which the routine 159B is derived. It is noted that a total number of application actions (or device actions) in the routine 159B can be different from activities introduced in the content 158. For instance, the total number of application actions in the routine 159B can be less than activities introduced in the content 158 based on availability of applications (or devices) to the user. The generative model 191B can be trained differently from the generative model 191A, for instance, using a different set of training instances 180B.

As another example, the total number of application actions (or device actions) in the routine 159B can be more than activities introduced in the content 158. In some implementations, the triggering time and/or triggering locations of the application actions in the routine 159B can be different from the content 158 (if there is any), and can be personalized based on the metadata of the user (e.g., user activity data, user preference data, etc.).

In various implementations, by properly training or fine-tuning the generative model in determining one or more device actions (and/or application actions) to be performed as a routine to stimulate or enable the user to routinely perform one or more desired actions, time and resources spent in repeated determining a specific time and duration to control IoT devices and application for a corresponding function can be saved or reduced. The more complicated the user input (which describes the actions to be routinely performed), the more the saved time and resources in having routine content of a routine generated using the generative model. The routine content generated using the generative model can also be more comprehensive and have less or no conflict if user schedule or other metadata associated with the user is provided, which can hardly be possible with manual effort.

FIG. 2A illustrates a user interface of an assistant application showing a plurality of categories of actions (to be routinely performed) for selection by a user, in accordance with various implementations of the present disclosure. As shown in FIG. 2A, in some implementations, optionally, an assistant application (e.g., 140 in FIG. 1A) including a routine function can display an introduction page 200A associated with the routine function, where the introduction page 200 can list a plurality of categories of actions to be routinely performed, for the user to choose from. The categories can include, for instance, health category 200a, financial category 200b, home improvement category 200c, relationship category 200d, self-development category 200e, etc.

FIG. 2B illustrates an example of routine content visualized at a user interface of a client computing device 20 in response to receiving user input indicating a list of actions to be routinely performed, in accordance with various implementations of the present disclosure. As shown in FIG. 2B, a user can provide a user input 201, such as “My goals are to eat healthier, take vitamins, get outside more, invest in deep work, learn more relationships, and read more per day”. In this example, the user input 201 may include a first action 201a to be routinely performed (i.e., “eat healthier”), a second action 201b to be routinely performed (i.e., “take vitamins”), a third action 201c to be routinely performed (i.e., “get outside more”), a fourth action 201d to be routinely performed (i.e., “invest in deep work”), a fifth action 201e to be routinely performed (i.e., “learn more relationships”), and a sixth action 201f to be routinely performed (i.e., “read more per day”).

In response to receiving the user input 201, the routine engine 145 can determine metadata (e.g., device location, functions, application or device activities, etc., not shown in FIG. 2B) associated with devices and/or applications available to the user, and metadata (e.g., user schedule, not shown in FIG. 2B) associated with the user of the user input 201. The user input 201, the metadata associated with the devices and/or applications available to the user, and the metadata associated with the user of the user input 201 can be processed, e.g., using a generative model (e.g., 191A in FIG. 1B), to generate model output reflecting a routine 203 that consists of a plurality of application actions to be routinely performed.

Optionally, the above model output can further reflect a respective time at which, or a respective time period during which, each of the plurality of application actions (or device actions) is to be performed. In this case, optionally, the routine 203 can list the plurality of application actions in a temporal order based on the respective time at which (or the respective time period during which) each application action is to be performed.

Optionally, the routine 203 can be a daily routine, a weekday routine, a weekend routine, a holiday routine, a weekly routine, or a monthly routine, etc. Optionally, the aforementioned model output can indicate that the plurality of application actions (or device actions) are to be performed routinely at different frequencies. In this case, for instance, more application actions can be listed for Wednesday than for Friday, as part of the routine 203. Optionally, a particular application action can be performed as part of the routine 203 using a particular application at a first specific time on a weekday, while the same particular application action (or a variation thereof) can be performed using the particular application at a second specific time during weekend (e.g., on Saturday). The second specific time can be different from the first specific time.

Optionally, routine content of the routine 203 can be accessed by a user via a user interface 200B of the assistant application, where the user can edit or modify the routine content rendered at the user interface 200B.

As shown in FIG. 2B, routine content of the routine 203 (e.g., for a weekday) can include a first notification 203A that reminds the user to eat breakfast (which corresponds to the first action 201a to be routinely performed) using healthy ingredients in a smart fridge. The first notification 203A can be rendered at a first time T1 (e.g., rendered in response to detecting the user completes brushing of her teeth in the morning using a smart toothbrush). The first notification 203A can be rendered using an alarm application, or via a message generated using an assistant application (e.g., 140 in FIG. 1A). The first notification 203A can be paired with a first application action performable via a first application 203a that controls the smart fridge. The first application action can be triggered in response to detecting the user within a first predefined distance with respect to the smart fridge, during a predefined period for eating breakfast. The first application action can be triggered, for instance, to cause a display screen of the smart fridge to display a breakfast recipe determined based on available ingredients currently available in the smart fridge and/or based on food information associated with the user (e.g., any food allergy or preference). Alternatively, or additionally, the display screen of the smart fridge can include location information of ingredients listed in the breakfast recipe and stored in the smart fridge.

Optionally, the first notification 203A can be paired with a second application action performable via a second application 203b that controls a first smart cooking device determined based on the breakfast recipe. The first smart cooking device can be, for instance, a smart toaster to cook the number of bagels as recommended in the breakfast recipe. The second application action can correspond to displaying cooking settings or parameters (e.g., cooking temperature, cooking time, etc., that are determined based on the breakfast recipe) via a screen of the first smart cooking device in response to detecting the user being within a second predefined distance with respect to the first smart cooking device, and during the predefined period for the user to eat breakfast.

In some implementations, as shown in FIG. 2B, the routine 203 can include a second notification 203B that reminds the user to take vitamins (which is the second action 201b to be routinely performed) stored in a smart pill organizer. The second notification 203B can be rendered at a second time T2 (e.g., rendered in response to detecting the aforementioned smart toaster finished preparing the amount of bagels as identified in the breakfast recipe), where the second time T2 can be the same as, or different from the first time T1 (e.g., subsequent to the first time). The second notification 203A (e.g., a sound, a message, etc.) can be rendered using an alarm application installed at the client computing device 20 of the user, or via a message generated using an assistant application (e.g., 140 in FIG. 1A). The second notification 203B can be paired with a third application action performable via a third application 203c that controls the smart pill organizer. The third application action can be triggered in response to detecting the user within a third predefined distance with respect to the smart pill organizer. The third application action can be triggered, for instance, to cause a specific compartment of the smart pill organizer that stores vitamins to be opened.

In some implementations, as shown in FIG. 2B, the routine 203 can include a third notification 203C that reminds the user that the client computing device 20 is placed in a silent mode where notifications from one or more applications (e.g., social media application, shopping application, etc.) installed at the client computing device 20 are muted (e.g., for 2 hours for “deep work”). The third notification 203C can be rendered as a pop-up message via the client computing device 20 at a third time T3 (e.g., the time when the user arrives in the office). The third notification 203C can be paired with an assistant application action (which is to help the user develop the fourth action 201d of “invest in deep work”) performed via the assistant application 140. The assistant application 140 can perform the assistant application action to configure the client computing device 20 in a silent mode where notifications from one or more applications (e.g., social media application, shopping application, etc.) installed at the client computing device 20 are muted.

As shown in FIG. 2B, the routine 203 can include a fourth notification 203D that reminds the user to eat dinner (which helps the user to develop the first action 201a of “eat healthier”) using healthy ingredients in the smart fridge (e.g., at home). The fourth notification 203D can be rendered at a fourth time T4 (e.g., rendered in response to activities of a smart garage indicating that the user has arrived home). The fourth notification 203D can be rendered using an alarm application, or via a message generated using an assistant application (e.g., 140 in FIG. 1A). The fourth notification 203D can be paired with a fourth application action performable via the first application 203a that controls the smart fridge. The fourth application action can be triggered in response to detecting the user within the first predefined distance with respect to the smart fridge. The fourth application action can be triggered, for instance, to cause a display screen of the smart fridge to display a dinner recipe determined based on available ingredients currently available in the smart fridge and/or based on food information associated with the user (e.g., any food allergy or preference). Alternatively, or additionally, the display screen of the smart fridge can include location information of ingredients listed in the dinner recipe and stored in the smart fridge.

Optionally, the fourth notification 203D can be paired with a fifth application action performable via a fifth application 203e that controls a second smart cooking device determined based on the dinner recipe. The second smart cooking device can be, for instance, a smart rice cooker to cook the amount of rice and/or other ingredient(s) as recommended in the dinner recipe. The fifth application action can correspond to displaying cooking settings or parameters (e.g., cooking temperature, cooking mode, cooking time, etc., that are determined based on the dinner recipe) via a screen of the second smart cooking device in response to detecting the user being within a fourth predefined distance with respect to the second smart cooking device.

In some implementations, as shown in FIG. 2B, the routine 203 can include a fifth notification 203E that reminds the user to take a walk after dinner (which is associated with the third action 201c of “get outside more”). The fifth notification 203E can be rendered at a fifth time T5 (e.g., rendered in response to determining a smart dishwasher started washing plates used for the dinner). The fifth notification 203E (e.g., a sound, a message, etc.) can be rendered using an alarm application installed at the client computing device 20 of the user, or via a message generated using an assistant application (e.g., 140 in FIG. 1A). The fifth notification 203E can be paired with a sixth application action performable via a sixth application 203f which can be a map application. The sixth application action can be triggered (e.g., by selecting a portion of the fifth notification 203E that identifies the map application, e.g., “Map app” in FIG. 2B) to cause a walking path to be recommended and rendered visually to the user via the map application, where the walking path can vary from day to day.

In some implementations, as shown in FIG. 2B, the routine 203 can include a sixth notification 203F that reminds the user to read a book about relationships (which is associated with the fifth action 201e of “learn more relationships” and the sixth action 201f of “read more per day”). The sixth notification 203F can be rendered at a sixth time T6 (e.g., an hour prior to bedtime of the user). The sixth notification 203F (e.g., a sound, a message, etc.) can be rendered using an alarm application installed at the client computing device 20 of the user, or via a message generated using an assistant application (e.g., 140 in FIG. 1A). The sixth notification 203F can be paired with a seventh application action performable via a seventh application 203g which can be a reading application. The seventh application action can be triggered (e.g., by selecting one or more words in the sixth notification 203F, such as “this article” in FIG. 2B) to cause the reading application to launch in a specific state where a page introducing an article or a book helping the user to “learn more relationships” is displayed. It is noted that, the specific content (e.g., recommended articles, etc.) of the sixth notification 203F (or other notifications) can vary on different days (or other times at which the seventh application action is to be performed).

It is noted that, the first time T1, the second time T2, the third time T3, the fourth time T4, the fifth time T5, and the sixth time T6 can be at least partially different from each other, and may not be the exactly the same as each other. Further, it is noted that the notifications described with respect to FIG. 2B and illustrated in FIG. 2B are for purposes of describing the routine 203 that can be generated and executed based on the user input 201 and are not meant to be limiting. Rather, it should be understood that various device and/or application actions associated with the routine 203 that is generated based on the user input 201 can be automatically performed without any notifications being rendered and based on various triggering criteria associated with each of the actions.

In some implementations, the routine 203 can include a seventh notification 203G that informs the user that activities of one or more applications (e.g., food-ordering applications) are monitored to help the user develop or maintain one or more of the actions (e.g., 201a˜201f).

Optionally, while not illustrated in FIG. 2B, the user may provide a subsequent user input (not illustrated) such as “learn more about astrology”. In this case, the sixth notification 203F can be modified to remind the user to read more about managing relationships and astrology. The modified sixth notification 203F, for instance, can include a link to a podcast suggesting content regarding relationships on Mondays, Wednesdays, and Fridays, while including a link to a podcast suggesting content regarding astrology on Tuesdays, Thursdays, and Saturdays.

FIG. 2C depicts an example of a notification, in accordance with various aspects of the present disclosure. As shown in FIG. 2C, launching of or logging into the food-ordering application (or user activities within the food-ordering application, such as a search for a particular type of food) can be detected. In response to detecting a launching status (or log-in status, user search for the particular type of food) of the food-ordering application, the system (e.g., the assistant application 140) can generate a notification, such as a recommendation 206 (e.g., “I recommend ordering kale salad at restaurant A given the ingredient of this meal, the ratings of the restaurant, and your smart fridge hasn't had kale in stock for a while”) of a healthy meal to purchase through the food-ordering application. The recommendation can be generated, for instance, based on one or more user searches (e.g., a current search or historical searches, if with user permission) within the food-ordering application and/or based on metadata (e.g., food currently stocked or out-of-stock in the smart fridge) associated with the smart devices/applications that the user has access to.

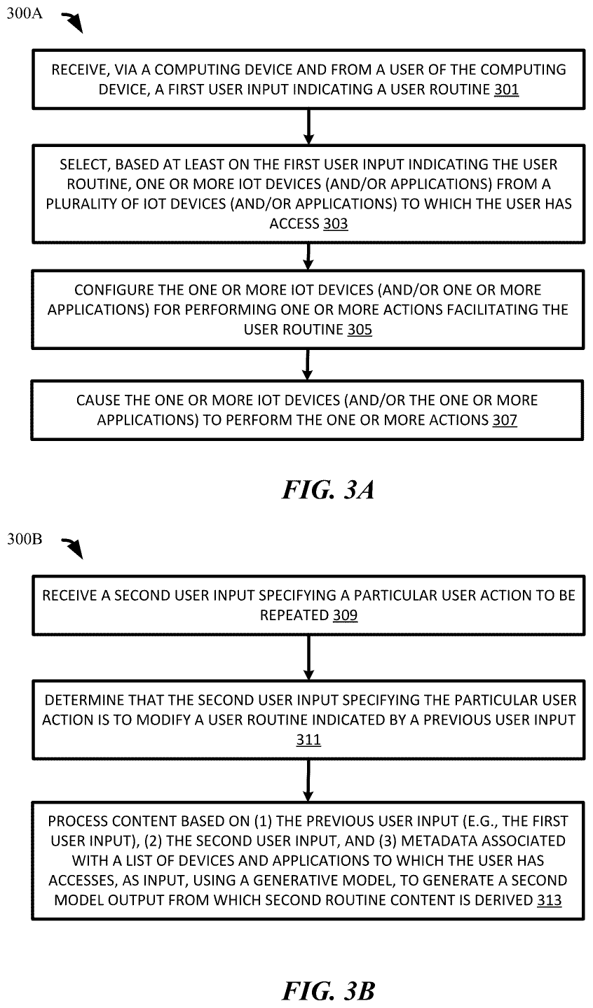

FIG. 3A depicts an example of a method for generating a routine, in accordance with various aspects of the present disclosure. A system for performing the method 300A includes one or more processors, memory, and/or other component(s) of computing device(s) (e.g., client computing device 10 of FIG. 1, one or more servers, and/or other computing devices). Moreover, while operations of the method 300A are shown in a particular order, this is not meant to be limiting. One or more operations may be reordered, omitted, and/or added.

In various implementations, at block 301, the system receives, via a computing device and from a user of the computing device, a first user input indicating a user routine. The first user input, for instance, can include a plurality of keywords each corresponding to an action (or a type of action, e.g., “eat healthy”) to be routinely performed. As another example, the first user input can include a file (e.g., a published article, a webpage, a video, an audio file, etc.) describing a shared routine shared by an author (the same as, or different from the user). The shared routine can include one or more actions shared by the author to be routinely performed (e.g., on a daily basis, weekly basis, etc.) As a further example, the first user input can include a link to a file describing a routine (e.g., a shared routine).

In some of the various implementations, the first user input can include no application, or no identifier of any application, in association with the action (or the type of action). In other words, application(s) and/or device(s), and application action(s) and/or device actions, to be performed as part of a routine (e.g., device routine, or application routine, or a mixed device and application routine) that facilitates/supports the user routine, can be determined using subsequent steps as described below or elsewhere of this disclosure. In some of the various implementations, additionally, the first user input can include no specific time or time duration associated with the type of action.

In various implementations, at block 303, the system selects, based at least on the first user input indicating the user routine, one or more Internet of Things (IoT) devices (and/or one or more applications) from a plurality of IoT devices (and/or a plurality of applications) to which the user has access. Optionally, the system can select the one or more IoT devices (and/or the one or more applications) based on other factors such as a schedule of the user (e.g., indicated by calendar data or message data associated with the user), a location of the user, locations of the plurality of IoT devices, etc. In various implementations, at block 305, the system configures the one or more IoT devices (and/or the one or more applications) for routinely performing one or more actions (e.g., “device action(s)”, “application action(s)”, etc.) to facilitate the user routine.

The one or more actions to be routinely performed via the one or more selected IoT devices (and/or the one or more selected applications) can be different from the aforementioned one or more actions in the shared routine that is shared by the author. For instance, the file retrieved based on the first user input can describe a first action (e.g., daily workout using a treadmill) to be performed routinely in the morning, and the one or more actions configured by the system at block 305 can include a first device action corresponding to starting operation of a smart treadmill routinely in the late afternoon (e.g., in response to detecting the user entering the room in the basement where the smart treadmill is located), based on metadata of the user indicating that the user has a long morning commute to the work office.

In some implementations, the system selects the one or more IoT devices (and/or the one or more applications) based on processing the first user input and metadata associated with the plurality of IoT devices (and/or the one or more applications) to which the user accesses, using a generative model. For instance, content (that is based on both the first user input and metadata associated with the plurality of IoT devices to which the user accesses) can be processed as input, using the generative model, to generate a first model output from which first routine content can be derived. The first routine content can include identifiers of the one or more IoT devices selected from the plurality of IoT devices to which the user accesses. Additionally, or alternatively, the first routine content derived from the model output can include the one or more actions to be performed routinely by the one or more IoT devices to facilitate the user routine.

In some implementations, the generative model can be a large language model (“LLM”) having less than 100 billion parameters, an LLM having more than 100 billion parameters, or an LLM having over 200 billion parameters, etc. In some implementations, the generative model may be stored locally at the client computing device of the user. In some implementations, the generative model can be stored remotely at a server computing device. In some implementations, the generative model can be both at the server computing device and the client computing device.

In some implementations, the generative model may be trained using enormous amounts of data collected from diverse sources such as webpages, electronic books, software code, electronic news articles, and machine translation data. In some implementations, the generative model can be fine-tuned using one or more training instances (e.g., 180A or 180B in FIG. 1B or 1C). The one or more training instances can include a first training instance, where the first training instance can include a first training instance input that include (1) a first manually curated user input describing a first series of actions and (2) a first list of devices and/or applications. The first training instance can further include a first ground truth output including one or more devices and/or applications selected from the first list, and/or device actions (or application actions) associated with the one or more devices and/or applications selected from the first list. The first training instance can be applied to fine-tune the generative model. For instance, the first training instance input can be processed as input, using the generative model, to generate a first model output from which a first training instance output is derived. Parameters of the generative model can be fine-tuned based on comparing the first training instance output with the first ground truth output.

Additionally, or alternatively, the one or more training instances can include a second training instance, where the second training instance can include a second training instance input that includes (1) a second manually curated user input describing a second series of actions and (2) a second list of devices and/or applications. The second training instance can further include a plurality of output each including one or more devices and/or applications selected from the second list (and/or device actions, or application actions, associated with the one or more devices and/or applications selected from the second list) and a rating score (“user feedback”) for each of the plurality of output. The second training instance can be applied to fine-tune the generative model, via reinforcement learning by human feedback (RLHF).

In various implementations, at block 307, the system causes the one or more IoT devices (and/or the one or more applications) to routinely perform the one or more actions. In some implementations, the system can cause a first IoT device from the one or more IoT devices to perform a first action that facilitates the user routine in response to a location of the user being within a predefined distance with respect to the first IoT device. Additionally, or alternatively, the system can cause a first application from the one or more selected applications to perform a first application action that facilitates the user routine.

In some implementations, the one or more actions can be initiated/performed at different times. Additionally, or alternatively, the one or more actions can be performed for different periods of time. Additionally, or alternatively, the one or more actions can be performed at different frequencies. For instance, a first device action (from the one or more actions) can be performed at a first frequency (e.g., every Monday, every Wednesday, and every Friday), and a second device action (from the one or more actions) can be performed at a second frequency (e.g., every Friday and Saturday).

In various implementations, the system further causes one or more calendar slots to be populated in a calendar application with reminder content that reminds the user to routinely perform one or more activities, where the reminder content can be determined based on the user input that indicates the user routine. For example, in various implementations, the aforementioned first user input can include one or more actions to be repeated as part of the user routine. In this case, the system can further cause one or more calendar slots to be populated in a calendar application with respective reminder content each reminding the user to perform one of the one or more actions specified in the first user input.

In various implementations, additionally, or alternatively, the system further configures an alarm application to create an alert that specifies a starting time and/or an ending time for a particular action specified in the first user input, where the alert includes alert content alerting the user to perform the particular action. In some of the various implementations, the system causes the alarm application to render the alert at the specified starting time, as part of the user routine. In some of the various implementations, the alert content identifies a link to media content.

In various implementations, additionally, or alternatively, the system further configures an assistant application to monitor activities (e.g., launch, log-in, add items to a shopping cart, check out an order, etc.) of one or more applications or services that the user has access to. For instance, the system can monitor a food-ordering application based on the first user input indicates a goal (or an action) of “eating healthier”, and in response to detecting the food-ordering application being accessed by the user, generate a recommendation that recommends a restaurant for ordering healthy food (or that recommends a healthy meal and a list of restaurants that offers the healthy meal). The system can cause the recommendation to be rendered via a client device of the user. Optionally, the system can cause the recommendation to be rendered as a pop-up message with respect to a user interface of the food-ordering application. Alternatively, or additionally, in response to detecting the food-ordering application being accessed by the user, the system can generate a reminder of ingredients currently in stock at a smart fridge the user has, and/or a recommendation for a recipe using one or more of the ingredients currently in stock at the smart fridge of the user.

In various implementations, the system determines whether the one or more actions are performed (e.g., routinely performed) to facilitate the user routine; generates a report reporting whether the one or more actions are performed to facilitate the user routine; and causes the report to be rendered to the user. The report can be a daily report reporting whether the user misses a user activity recommended (or scheduled) for the day as part of the user routine, or a weekly report (monthly report, annual report, etc.) reporting a percentage of the user in completing the user routine.

In various implementations, the system receives additional user input that modifies the user routine; and in response to receiving the additional user input that modifies the user routine, the system updates a selection of the one or more IoT devices in accordance with the modified user routine. In some of the various implementations, the system updates the selection of the one or more IoT devices by adding (or deleting) a particular IoT device to the one or more IoT devices. In some of the various implementations, the system configures the added particular IoT device for performing a corresponding action associated with the user routine.

In various implementations, the system receives additional user input that modifies the user routine; and in response to receiving the additional user input that modifies the user routine, the system modifies the one or more actions to be routinely performed using the one or more IoT devices in accordance with the modified user routine.

FIG. 3B depicts an example of a method for updating a routine, in accordance with various aspects of the present disclosure. A system for performing the method 300B includes one or more processors, memory, and/or other component(s) of computing device(s) (e.g., client computing device 10 of FIG. 1, one or more servers, and/or other computing devices). Moreover, while operations of the method 300B are shown in a particular order, this is not meant to be limiting. One or more operations may be reordered, omitted, and/or added.

In various implementations, at block 309, the system receives a second user input specifying a particular action to be routinely performed.

In various implementations, at block 311, the system determines that the second user input specifying the particular action is to modify a user routine indicated by a previous user input (e.g., the first user input at block 301). In this case, at block 313, the system can process content based on (1) the previous user input (e.g., the first user input), (2) the second user input, and (3) metadata associated with a list of devices and applications to which the user has accesses, as input, using the generative model, to generate a second model output from which second routine content facilitating the modified user routine is derived. The second routine content can include an updated list of IoT devices to perform one or more updated actions that facilitate the modified user routine. In various implementations, the system configures the updated list of IoT devices to perform the one or more updated actions that facilitate the modified user routine.

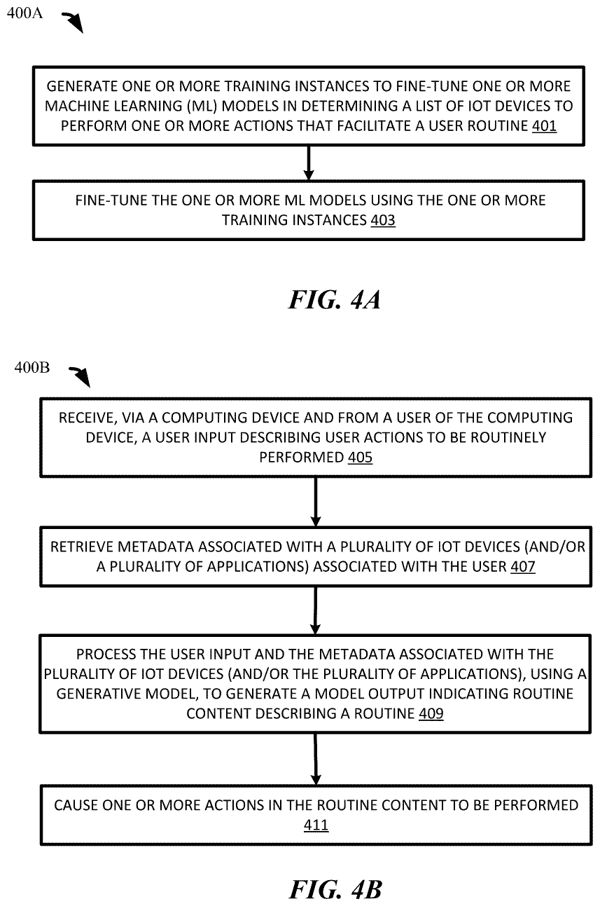

Turning now to FIG. 4A, a flowchart illustrating a method of training one or more generative models, in accordance with various aspects of the present disclosure. A system for performing the method 400A includes one or more processors, memory, and/or other component(s) of computing device(s) (e.g., client computing device 10 of FIG. 1, one or more servers such as the server computing device 12, and/or other computing devices). Moreover, while operations of the method 400A are shown in a particular order, this is not meant to be limiting. One or more operations may be reordered, omitted, and/or added.

In various implementations, as shown in FIG. 4A, at block 401, the system generates one or more training instances to fine-tune one or more machine learning (ML) models in determining a list of IoT devices to perform one or more actions that facilitate a user routine. In some implementations, the one or more training instances can include a first training instance, where the first training instance can include a first training instance input that include (1) a first manually curated user input describing a first series of actions and (2) a first list of devices and/or applications. The first training instance can further include a first ground truth output including one or more devices and/or applications selected from the first list, and/or device actions (or application actions) associated with the one or more devices and/or applications selected from the first list. The first training instance can be applied to fine-tune the generative model. For instance, the first training instance input can be processed as input, using the generative model, to generate a first model output from which a first training instance output is derived. Parameters of the generative model can be fine-tuned based on comparing the first training instance output with the first ground truth output.

Additionally, or alternatively, the one or more training instances can include a second training instance, where the second training instance can include a second training instance input that includes (1) a second manually curated user input describing a second series of actions and (2) a second list of devices and/or applications. The second training instance can further include a plurality of output each including one or more devices and/or applications selected from the second list (and/or device actions, or application actions, associated with the one or more devices and/or applications selected from the second list) and a rating score (“user feedback”) for each of the plurality of output. The second training instance can be applied to fine-tune the generative model, via reinforcement learning by human feedback (RLHF).

In various implementations, at block 403, the system fine-tunes the one or more ML models using the one or more training instances. In some implementations, the system fine-tunes the one or more ML models by fine-tuning the one or more ML models using the first training instance, or using the second training instance.

FIG. 4B depicts another example of a method for generating a routine, in accordance with various aspects of the present disclosure. A system for performing the method 400A includes one or more processors, memory, and/or other component(s) of computing device(s) (e.g., client computing device 10 of FIG. 1, one or more servers, and/or other computing devices). Moreover, while operations of the method 400B are shown in a particular order, this is not meant to be limiting. One or more operations may be reordered, omitted, and/or added.

In various implementations, at block 405, the system receives, via a computing device and from a user of the computing device, a user input describing actions to be routinely performed.

In various implementations, at block 407, the system retrieves metadata associated with a plurality of Internet of Things (IoT) devices (and/or a plurality of applications) to which the user has access. The system can retrieve the metadata associated with the plurality of IoT devices in response to receiving the user input describing the actions to be routine performed.

In various implementations, at block 409, the system processes the user input and the metadata associated with the plurality of IoT devices (and/or a plurality of applications) to which the user has access, using a generative model (e.g., one or more of the fine-tuned ML models at block 403), to generate model output from which routine content describing a routine is derived.

In some of the various implementations, the routine content can include, for instance, one or more IoT devices (and/or one or more applications) selected from the plurality of IoT devices (and/or the plurality of applications), and/or one or more actions to be routinely performed via the one or more selected IoT devices (and/or the one or more selected applications). Additionally, or alternatively, the routine content includes specific time or time slots/durations for the one or more actions to be routinely performed via the one or more IoT devices (and/or the one or more applications). Additionally, or alternatively, the routine content includes control signals that populates one or more calendar slots in a calendar application with reminder content that reminds the user to perform an activity, the reminder content determined based on the user input that describes the actions to be routinely performed. The description of the routine content is, however, not limited thereto, and more detailed descriptions can be found elsewhere in this disclosure.

In various implementations, at block 411, the system causes the one or more IoT devices (and/or one or more applications) to routinely perform the one or more actions in the routine content (e.g., determined based on the model output of the generative model that corresponds to the user input and the metadata associated with the one or more IoT devices and applications to which the user has access).

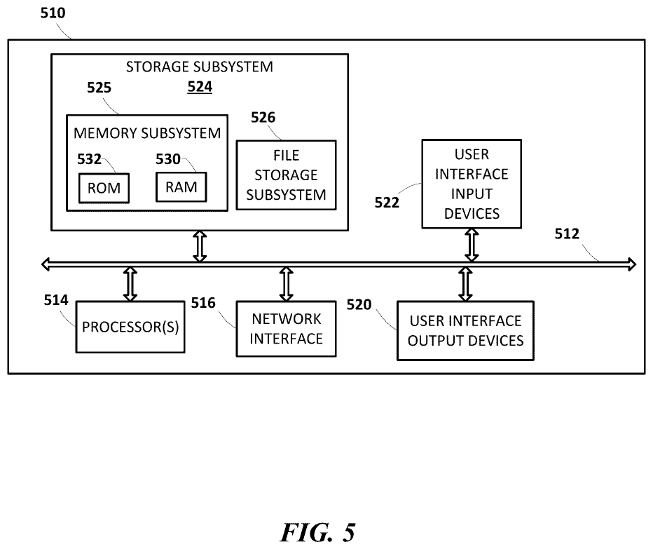

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented using one or more processors, the method comprising:
receiving, via a computing device and from a user of the computing device, user input describing at least one type of action to be routinely performed, wherein the user input does not identify device or application in association with the at least one action;
retrieving metadata associated with a plurality of devices and applications to which the user has access via the computing device;
processing at least the user input and the metadata associated with the plurality of device and applications to which the user has access via the computing device, using a generative model, to generate model output reflecting routine content that describes a routine;
wherein the routine content identifies one or more devices, selected from a plurality of devices, that will routinely perform one or more actions in furtherance of the user routine; and
causing the one or more devices to routinely perform the one or more actions, in the routine content, that are determined based on the model output of the generative model.

2. The method of claim 1, wherein the routine content further identifies one or more applications, selected from a plurality of applications, that will routinely perform one or more additional actions in furtherance of the user routine.

3. The method of claim 2, wherein the metadata further includes one or more corresponding actions that are performable by each of the applications.

4. The method of claim 1, wherein the metadate further include one or more corresponding actions that are performable by each of the devices, and wherein the devices are Internet-of-Things (IoT) devices defined in a device topology representation that is associated with a primary dwelling of the user.

5. A method implemented using one or more processors, the method comprising:
receiving, via a computing device and from a user of the computing device, user input describing at least one type of action to be routinely performed, wherein the user input does not identify device or application in association with the at least one action;
retrieving metadata associated with a plurality of devices and applications to which the user has access via the computing device;
processing at least the user input and the metadata associated with the plurality of device and applications to which the user has access via the computing device, using a generative model, to generate model output reflecting routine content that describes a routine;
selecting, based at the output, one or more applications from a plurality of applications and devices to which the user has access;
configuring the one or more applications for performing one or more application actions determined based on the user input, as a routine; and
causing the one or more applications to routinely perform the one or more application actions.

6. The method of claim 5, wherein configuring the one or more applications for performing the one or more application actions comprises:
populating one or more calendar slots in a calendar application with reminder content that reminds the user to perform an activity, the reminder content determined based on the user input that describes the at least one type of action to be routinely performed.

7. The method of claim 6, wherein causing the one or more applications for performing the one or more application actions comprises:
receiving a location of the user; and
causing the reminder content to be rendered to the user based on the location of the user, as part of the routine that includes the one or more application actions.

8. The method of claim 5, wherein configuring the one or more applications for performing the one or more application actions further comprises:
configuring an alarm application to create an alert that specifies a starting time and/or an ending time for a particular action associated with the at least one type of action identified in the user input, wherein the alert includes alert content alerting the user to perform the particular action.

9. The method of claim 8, wherein causing the one or more applications for performing the one or more application actions comprises:
causing the alarm application to render the alert at the specified starting time, as part of the routine.

10. The method of claim 8, wherein the alert content identifies a link to media content.

11. The method of claim 5, further comprising:
determining whether the one or more application actions are performed as the routine;
generating a report reporting whether the one or more application actions are performed as the routine; and
causing the report to be rendered to the user.

12. The method of claim 5, further comprising:
receiving additional user input that modifies the routine; and
in response to receiving the additional user input that modifies the routine, updating the one or more applications in accordance with the modified routine.

13. The method of claim 12, wherein updating the one or more applications in accordance with the modified routine comprises:
adding a particular application to the one or more applications, or
deleting an existing application from the one or more applications.

14. The method of claim 12, further comprising:
configuring the one or more updated applications for performing one or more modified actions associated with the modified routine.

15. The method of claim 5, wherein causing the one or more applications to routinely perform the one or more actions comprises:
causing the one or more applications to perform the one or more actions at respectively times determined based on a schedule of the user.

16. The method of claim 5, further comprising:
monitoring an application accessible by the user, the application determined based on the user input that describes the at least one type of action to be routinely performed; and
causing a notification to be rendered to the user in response to detecting usage of the application deviates from the user input that describes the at least one type of action to be routinely performed.

17. The method of claim 16, wherein the notification includes a recommendation recommending an application action in consistent with the at least one type of action in the user input, wherein the recommendation is selectable and, when selected, causes an additional application to be launched for performing the recommended application action.

18. A method implemented using one or more processors, the method comprising:
receiving, via a computing device and from a user of the computing device, a user input corresponding to content from an additional user that shares actions to be routinely performed;
retrieving metadata associated with a plurality of applications to which the user has access;
retrieving metadata associated with the user;
processing the content from the additional user that shares the actions to be routinely performed, the metadata associated with the plurality of applications to which the user has access, and the metadata associated with the user, using a generative model, to generate model output from which routine content describing a routine is derived,
wherein the routine content includes one or more applications selected from the plurality of applications and one or more application actions to be routinely performed via the one or more applications; and
causing the one or more applications to routinely perform the one or more actions in the routine content.

19. The method of claim 18, wherein the metadata associated with the user includes a pattern of user activities of the user.

20. The method of claim 18, wherein the routine content includes a respective time or time period for a respective application action, from the one or more application actions, to be routinely performed.
